(19) United States
(12) Patent Application Publication
(10) Pub. No.: US 2003/0043427 A1
(43) Pub. Date: Mar. 6, 2003

(54) Method of fast circuit recovery using local restoration

(76) Inventors: Marc Robidas, Chelmsford, MA (US); Ray Alexander Balogh, North Andover, MA (US); Alok Kishore Bhargava, Burlington, MA (US); Arvind Puntambekar, Westford, MA (US)

Correspondence Address: LAHIVE & COCKFIELD, 28 STATE STREET, BOSTON, MA, 02109, US

(21) Appl. No.: 09/943,661

(22) Filed: Aug. 30, 2001

(51) Int. Cl. H04B 10/08; H04B 10/20; H04J 14/00

(52) U.S. Cl. 359/110; 359/118

(57) ABSTRACT

A communication network and method is presented that performs line level restoration when an indication of a trunk failure is received. When a trunk failure occurs, the optical cross connect switch detecting the failure signals upstream to a peer optical cross connect switch of the failure occurrence. The optical cross connect switch having the higher router ID performs an alternative trunk query and if an alternative trunk is located, the two nodes located at each end of the failed trunk migrate the eligible label switched paths onto the new trunk.

### TECHNICAL FIELD OF THE INVENTION

This invention relates to optical networks, and more particularly, to an apparatus and method for restoring operation of the optical network when a trunk within the optical network becomes inoperative.

### BACKGROUND OF THE INVENTION

When a trunk fails on an established circuit, typical network layer restoration is accomplished by a complete teardown of the established circuit through the communication network and rebuilding of the circuit from the source node to the destination node with an alternative route. As a result, information in the switches must be updated to re-establish the circuit. When a circuit spans several hops, the time required for updating may be objectionable. Furthermore, until the communication network reconverges, it is in an unstable state in which routing loops and black holes can occur. Consequently, the extended convergent times associated with layer three restoration significantly compromise routing and network stability.

### SUMMARY OF THE INVENTION

The present invention addresses the above-described limitations associated with failure restoration in an optical communication network. The present invention provides an approach to restoration that minimizes routing instability caused by extended routing convergence times commonly associated with layer three restoration. The present invention minimizes network instability by overcoming the need to teardown an established circuit when a fault is detected.

In one embodiment of the present invention, a method is performed in a switched communication network having an optical layer for handling a failure of an established circuit in the optical layer to avoid teardown and reestablishment of the established circuit. Upon the detection of a failure in the established circuit between a pair of nodes, either the first node or the second node reports the circuit failure to a control node. The control node, known as the trunk allocator, is the node with the highest IP router address between the first node and the second node. Upon receipt of the failure indication at the control node, the control node restores the established circuit between the first node and the second node to restore sufficient operability to the established circuit.

The above-described approach benefits the switched communication network operator in the event of an established circuit failure because the established circuit does not need to be torn down. As a result, network stability is increased and data transport errors are minimized. Moreover, the restoration method may also increase the network operator's revenue by insuring that circuit restoration completes within a short period of time.

In accordance with another aspect of the present invention, a communication network is provided that includes an optical layer having a plurality of optical nodes that define voice and data paths in the optical layer. The communication network also includes a network management operating system that allows the optical nodes to locally restore a failed trunk without having to teardown the established circuit and reestablish the circuit from the source node. The optical nodes of the communication network are laid out in a mesh topology. The network management operating system invokes the optical nodes having the higher router identification as the node that operates to perform the restoration of the detected inoperative optical voice and data path.

The above described approach improves circuit restoration time as well as decreasing the amount of network-wide traffic control that is required to restore circuits upon failure of a trunk element. In addition, the constraint based routing in the communication network notably benefits traffic engineering and fast re-route. As a consequence, circuit protection and restoration can occur above the SONET ASP protection scheme and above the SDH MSP protection scheme.

In yet another aspect of the present invention, a method is practiced for restoring an established circuit in a communication network by detecting a failed trunk between a first optical node and a second optical node of the communication network. The detected trunk failure is reported to a trunk allocator node in the communication network where the trunk allocator node selects an alternative trunk coupled between the first optical node and the second optical node to restore the established circuit. When the established circuit is restored, the trunk allocator node routes network traffic over the alternative trunk. The trunk allocator also initiates the updating of the network topology database to indicate the selection of the alternative trunk.

### BRIEF DESCRIPTION OF THE DRAWINGS

An illustrative embodiment of the present invention will be described below relative to the following drawings.

FIG. 1 depicts an optical communication network suitable for practicing the illustrative embodiment of the present invention.

FIG. 2 is a flow chart illustrating the steps taken to restore a trunk in the LSP of FIG. 1.

FIG. 3 is a continuation of the flow chart of FIG. 3.

FIG. 4 is a continuation of the flow chart of FIG. 4.

### DETAILED DESCRIPTION OF AN ILLUSTRATIVE EMBODIMENT

The illustrative embodiment of the present invention is directed to restoration of an optical trunk in a communications network. Specifically, the illustrative embodiment is directed to a network and a method for restoring a failed trunk between two nodes in the optical layer of the network without utilizing SONET APS or SDH MPS. The restoration method of the present invention can restore trunks in kind. For Example, an OC-48 trunk can be restored onto an alternate OC-48 trunk, or a failed trunk can be restored across one or more trunks with different total bandwidth capacity. Thus, a failed OC-48 trunk can be restored onto an available OC-192 trunk, or a failed OC-192 trunk can be restored onto four OC-48 trunks.

The illustrative embodiment of the present invention is attractive for use in an optical communication network. The ability, for an optical node to perform restoration improves circuit restoration time and advantageously minimizes the amount of network control traffic that occurs to restore the established circuit.

The illustrative embodiment utilizes the constraint based routed label distribution signaling protocol (CR-LDP) to automate the establishment of an explicitly routed labeled switched path (LSP) through the network. Those skilled in the art will recognize that other signaling protocols, such as resource reservation protocol (RSVP), traffic engineering resource reservation protocol (TE-RSVP), data connection resource reservation protocol (DC-RSVP), or the like can be implemented as part of the protocol stack to establish an explicitly routed LSP.

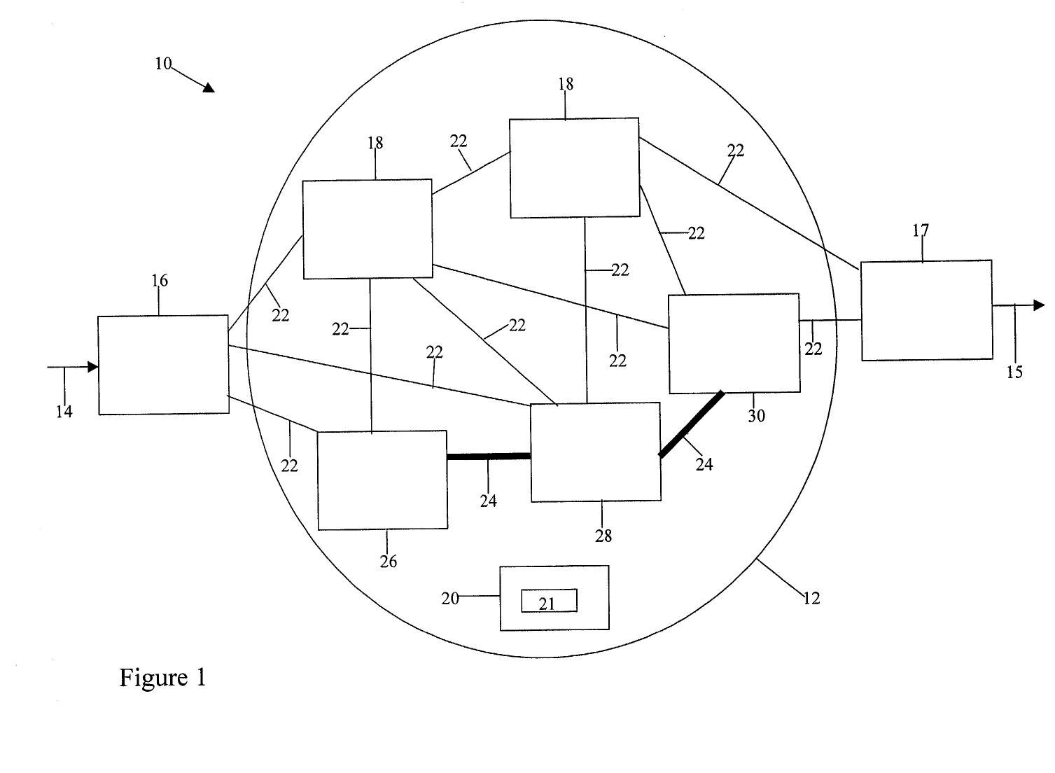

FIG. 1 is a block diagram of an exemplary communication network 10 that is suitable for implementing the illustrative embodiment of the present invention. The exemplary communication network 10 includes an optical network domain 12 coupled to optical edge routers 16 and 17. The optical edge routers 16 and 17 provide the gateways to the optical transmission layer of the optical network domain 12. Those skilled in the art will recognize that the exemplary communication network 10 is suitable for practice as a metropolitan area network (MAN) or a wide area network (WAN), or as a long haul network. Moreover, in the illustrative embodiment, the optical edge routers 16 and 17 may be the model SN 3000 optical access switch manufactured by Sycamore Networks, Inc. of Chelmsford Mass.

The optical network domain 12 of the exemplary communication network 10 utilizes a mesh topology to maximize the utilization of the optical cross connect switch 18, 26, 28, and 30. The optical cross connect switches 18, 26, 28, and 30 are equivalent optical switches and are referred to in this manner for illustrating the illustrative embodiment of the present invention. Nevertheless, those skilled in the art will recognize that the topology of the optical network domain 12 can also include a ring topology. Control over the optical network domain 12 is provided by a network operating system 20. The network operating system 20 includes an optical routing module 21 that performs optical routing definition across the optical network domain 12. In the illustrative embodiment, the optical cross connect switches 18, 26, 28, and 30 may be model SN 16000 optical switches manufactured by Sycamore Networks, Inc. of Chelmsford Mass.

The optical edge routers 16 and 17 operate as the gateways to the optical network domain 12. In this manner, the optical edge routers 16 and 17 provide a single ingress via the transmission path 14 and a single egress via the transmission path 15. Moreover, the optical edge router 16 performs the time-division multiplexing at the network ingress point to break each communication signal received on the transmission path 14 into time slots assigns each time slot to a composite signal in a rotating, repeating sequence for transport across the optical network domain 12 to the optical edge router 17. In like manner, the optical edge router 17 receives the composite signal and performs the time-division demultiplexing to separate out the data from each of the time slots for routing to the proper end users via the transmission path 15. The transmission paths 14 and 15 may be an optical transmission path, a coaxial transmission path, a twisted pair transmission path, or the like. Typically, the transmission paths 14 and 15 are coupled to one or more other networking devices, such as an asynchronous transfer mode (ATM) switch, an internet protocol (IP) router, a SONET/SDH device coupled to a private branch exchange (PBX), or the like.

The exemplary communication network 10 utilizes open shortest path first (OSPF) routing protocol to calculate the shortest path to each node based on a topography of the optical network domain 12. The OSPF routing protocol uses a link state algorithm to distribute network state information amongst the nodes of the exemplary communication network 10 and applies a shortest path first algorithm to calculate path lengths between nodes of the optical network domain 12. The network operating system 20 maintains a link state database that holds a virtual topology map for control and management.

To establish an LSP across the optical network domain 12 the exemplary communication network 10 utilizes the CR-LDP protocol to define the exchange of labels based on an explicit route set-up provided by the OSPF. Those skilled in the art will recognize that CR-LDP is a set of extensions to the LDP protocol specifically designed to facilitate constraint based routing of LSP's. The CR-LDP protocol utilizes the transmission control protocol (TCP) sessions between LSR pairs to send label distribution messages among the sessions.

In operation, the CR-LDP protocol sets up the cross connects on the LSP based on an explicit route that is provided by the OSPF protocol. That is, the OSPF protocol provides the signaling component of the CR-LDP protocol with the entire end to end circuit definition. The CR-LDP protocol then signals the setup of the circuit.

To set up and establish a circuit in the exemplary communication network 10 the network operating system 20 identifies the address of the source node and the address of the destination node along with circuit parameters, such as protection scheme, bandwidth, and the like. The network operating system 20 utilizing the CR-LDP protocol requests an optimal route from the source node to the destination node from the OSPF protocol.

One possible LSP through the optical network domain 12 is illustrated in FIG. 1 by the optical transmission path 24. Those skilled in the art will recognize that the optical transmission paths 22 and 24 contain the same physical transport capabilities; that is, they are both optical conductors. Those skilled in the art will appreciate that the exemplary LSP depicted in FIG. 1 can be extended to the transmission path coupling the optical edge router 16 and the optical cross connect switch 26 and the transmission path coupling the optical edge router 17 and the cross connect switch 30, if the optical edge routers 16 and 17 are a model SN 3000 manufactured by Sycamore Networks of Chelmsford, Mass.

As illustrated, the optical cross connect switch 26 forms the source node of the LSP, the optical cross connect switch 28 forms an intermediate node of the LSP, and the optical cross connect switch 30 forms the destination node of the LSP. The optical cross connect switch 26 interfaces with the optical edge router 16 to transmit data across the optical network domain 12.

With reference to FIG. 1, when either the optical cross connect switch 26, the optical cross connect switch 28, or the optical cross connect switch 30 detect a channel failure over the transmission path 24, the optical cross connect switch with the lower router ID, signals the failure detection to an optical cross connect switch having a higher router ID. The optical cross connect switch with the higher router ID, known as the trunk allocator or the control node then performs a trunk query through the optical routing module 21. If a new trunk is selected, the optical cross connect switch having the lower router ID is notified and begins to reconfigure itself to utilize the newly selected trunk. If there is any failure to allocate a new trunk or set up a cross connection by the trunk allocates or its peer restoration will not persist to heal the circuit and the circuit will be torn down from the source optical cross connect switch to the destination optical cross connect switch. For purposes of the discussion below, the optical cross connect switch 30 will be referred to as the optical cross connect switch with the lower router ID, while the optical cross connect switch 28 will be referred to as the optical cross connect switch with the higher router ID or the trunk allocator.

Typically, there are two types of failures that can be detected by two peer nodes. The two failure types include a local indication that the trunk has gone down, or a local or remote indication that a channel of the trunk has gone down. A trunk failure can be the result of a circuit card assembly pulled from either the optical cross connect switch 28 or the optical cross connect switch 30, a port or an optical cross connect switch that is administratively disabled, an out of frame event, a loss of frame event, a loss of clock event, a loss of signal event, a line alarm indication signal, or a line receiver data interface event at either the optical cross connect switch 28 or the optical cross connect switch 30. Those skilled in the art will recognize that the optical cross connect switch 26 may also be configured to perform trunk restoration between itself and the optical cross connect switch 28. Moreover, those skilled in the art will recognize that the optical cross connect switch 26 and the optical cross connect switch 30 can be configured to perform trunk restoration between the optical edge router 16 and the optical edge router 17.

A channel failure is indicated by either a path alarm indication signal or a path receiver data interface event detected by the optical cross connect switch 28 or the optical cross connect switch 30. Trunk and channel failures can be detected at both ends of the trunk; such as the optical cross connect switch 28 or the optical cross connect switch 30.

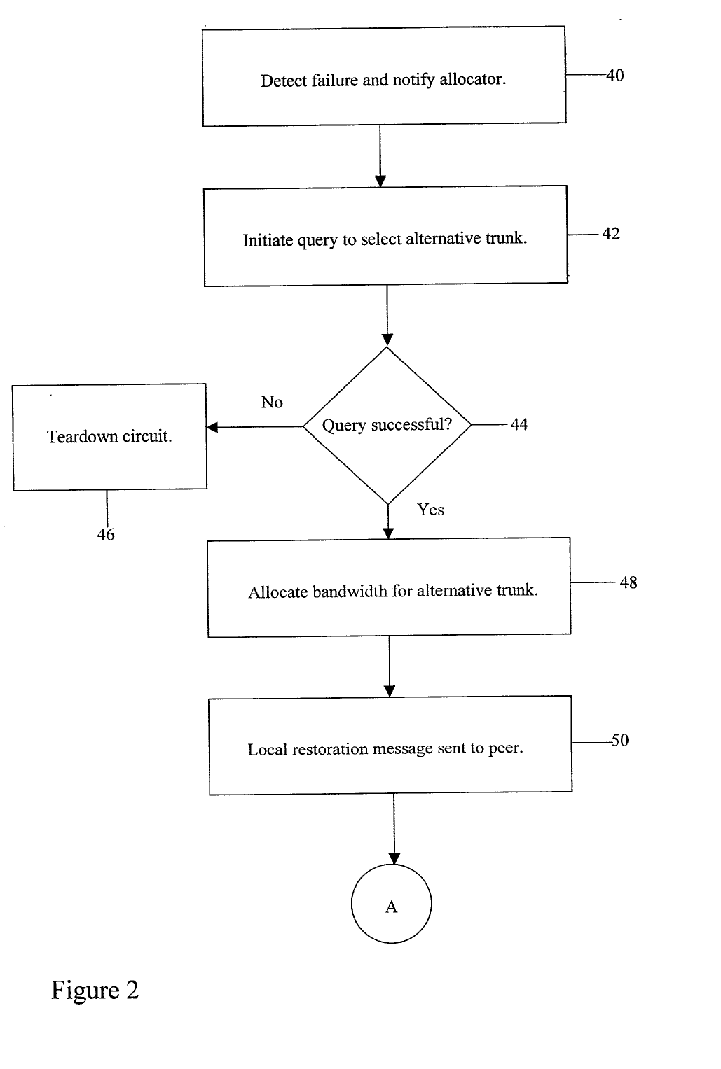

Upon detection of a trunk failure or a channel failure between two peer nodes, such as the optical cross connect switch 28 and the destination optical cross connect switch 30, the optical cross connect switch with the lower router ID notifies the optical cross connect switch with the higher router ID, the trunk allocator, of the detected failure (step 40 in FIG. 2). Those skilled in the art will recognize that the optical cross connect switch with the higher router ID, the optical cross connect switch 28, is also able to detect the trunk or channel failure and notify itself of the detected failure. Upon receipt of the failure notification at the trunk allocator, the trunk allocator initiates a query to select an alternative trunk between nodes at the optical routing module 21. The query specifies that a trunk should be selected with a circuit bandwidth equivalent of the failed trunk's bandwidth capacity (step 42 in FIG. 2). The trunk query performed by the optical cross connect switch 28 is designed to exclude the circuit's failed trunk.

If the trunk query is successful, (step 44 in FIG. 2) the optical cross connect switch 28 allocates bandwidth in the newly selected trunk for each LSP in the failed trunk with a circuit protection of either restored or preemptable (step 48 in FIG. 2). The optical cross connect switch 28 and the optical routing module 21 can allocate bandwidth for an alternative trunk in a number of ways. For example, the optical cross connect switch 28 and the optical routing module 21 can restore trunks only in kind. That is, an OC-48 trunk is restored onto an OC-48 trunk, or an OC-192 trunk is restored onto an OC-192 trunk. In similar fashion, optical cross connect switch 28 and the optical routing module 21 may restore the failed trunk with an alternate trunk having a different total bandwidth capacity. For example, a failed OC-48 trunk may be restored onto an available OC-192 trunk. Similarly, a failed OC-192 trunk may be restored onto four OC-48 trunks.

The optical routing module 21 of the network operating system 20 operates to minimize bandwidth fragmentation. Hence, when the optical routing module 21 receives a trunk query from the optical cross connect switch 28 for bandwidth to support an OC-48 trunk the optical routing module 21 prefers selecting an alternative OC-48 trunk over an alternative OC-192 trunk. However, in the absence of an OC-48 trunk, the optical routing module 21 can return an OC-192 trunk. Moreover, the optical cross connect switch 28 and the optical routing module 21 can be implemented so that if a trunk level in kind restoration is not available, the optical routing module 21 automatically attempts a trunk level restoration across mixed trunk bandwidth capacities. Further, if the optical routing module 21 cannot restore the trunk across mixed trunk bandwidth capacities, the optical routing module 21 and the optical cross connect switch 28 can trigger a restoration of individual LSPs. In this case, for each established LSP in the failed trunk, the optical routing module 21 starting with the LSP having the largest bandwidth, reroutes the largest capacity LSP onto an alternative trunk having bandwidth, available to meet the capacity demands of the individual LSP. If the trunk query is unsuccessful (step 44 in FIG. 2) the optical cross connect switch 26 tears down the established circuit and establishes a fresh circuit through the optical network domain 12 (step 46 in FIG. 2).

The trunk query by the optical cross connect switch 28 to the optical routing module 21 also serves to preserve the channel assignments during trunk restoration. The optical cross connect switch 28 in the trunk query specifies the channels that were originally allocated to the failed trunk. As a result, a single restoration message specifying the old trunk ID and the new ID is exchanged between the optical cross connect switch 28 and the optical routing module 21.

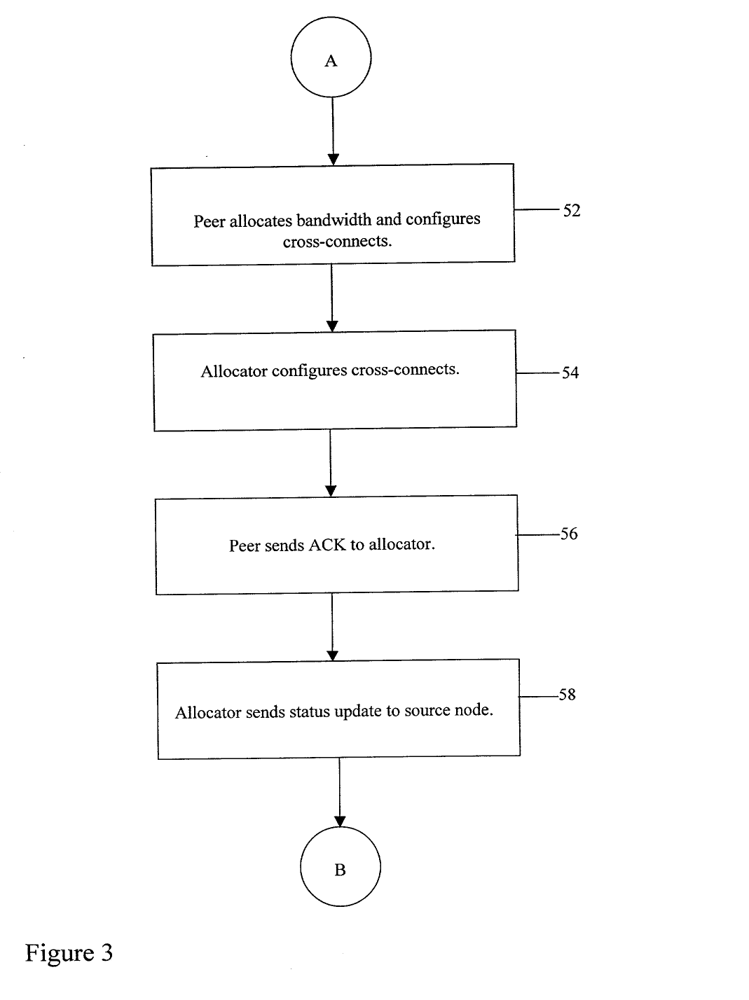

Upon allocation of sufficient bandwidth on an alternate trunk by the optical routing module 21, a restoration message is sent by the optical cross connect switch 28 to the downstream optical cross connect switch 30 (step 50 in FIG. 2). The downstream optical cross connect switch 30 allocates sufficient bandwidth at its input port and cross connects (step 52 in FIG. 3), while the optical cross connect switch 28 concurrently configures its output port and cross connects (step 54 in FIG. 3). When all cross connections are configured, a two-second response timer is initiated. Those skilled in the art will recognize that the response timer period can be increased or decreased as necessary. If the downstream optical cross connect switch 30 does not respond to the optical cross connect switch 28 within the two second window with an acknowledgment (Ack) (step 56 in FIG. 3) all restored and preemptable LSPs are torn down.

Upon the successful bandwidth allocation and cross connect configuration by the downstream optical cross connect switch 30 for the restored and preemptable LSPs, the downstream optical cross connect switch 30 sends a restoration Ack to the optical cross connect switch 28 (step 56 in FIG. 3). If the downstream optical cross connect switch 30 fails to establish its half of the trunk, the optical cross connect switch 28 signals to the optical cross connect switch 26 to tear down the circuit and establish a new circuit.

When the optical cross connect switch 28 receives the restoration Ack from the downstream optical cross connect switch 30, the optical cross connect switch 28 sends a status update, which includes a path trace update, upstream to the optical cross connect switch 26 (step 58 in FIG. 3). Those skilled in the art will recognize that the path trace update can be the path trace update type length value (TLV) encoding scheme of the LDP specification. Typically, the trace path update is a list or table that specifies the trunk IDs and router IDs for a LSP that has been replaced.

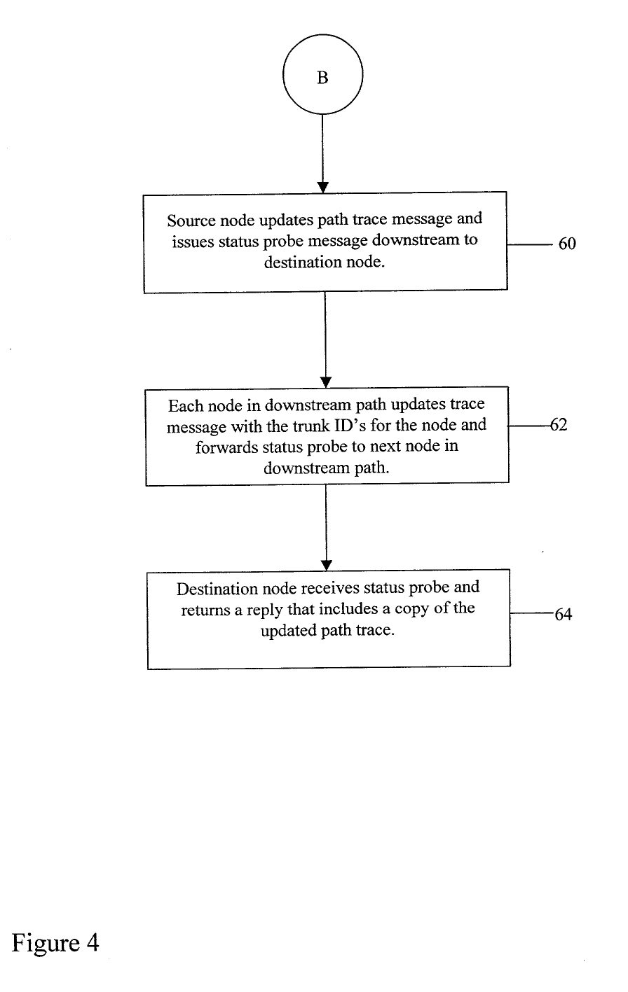

Upon receipt by the optical cross connect switch 26 of the status change message, which contains the path trace update from the optical cross connect switch 28, the source optical cross connect switch 26 updates the complete path trace and sends a status probe message downstream (step 60 in FIG. 4). Each optical cross connect switch in the downstream path, such as the optical cross connect switch 28 and the optical cross connect switch 30, update the path trace with the proper trunk IDs for its hop and forwards the status probe downstream to the next optical cross connect switch. In addition, each optical cross connect switch in the downstream path also replies upstream to the optical cross connect switch 26 with a status probe reply that contains a copy of the path trace from the status probe (step 62 in FIG. 4). When the optical cross connect switch 30 receives the status probe, the optical cross connect switch 30 updates the path trace and returns a status probe reply that includes a copy of the updated path trace (step 64 in FIG. 4). All nodes in the upstream path update their internal path trace or forwarding table with the path trace information provided by the status probe reply from the optical cross connect switch 30. At this point the trunk is restored and the established circuit is again able to transmit data.

While the present invention has been described with reference to a preferred embodiment thereof, one skilled in the art will appreciate that there is changes in form and detail may be made without departing from the intended scope of the present invention as defined in the pending claims. For example, trunk restoration may be a network operator selectable feature or it may be a feature that the network operator cannot control. Moreover, trunk restoration is triggered if at least one LSP over the failed trunk is in an established state and the established circuit is configured for local trunk restoration. Furthermore, although only local restoration of a trunk for a single hop is described, local restoration of a trunk with two or more hops can be performed concurrently.

What is claimed is:

1. In a switched communication network having an optical layer for photonic transport of data, a method for handling a failure of an established circuit to avoid end-to-end tear down and re-establishment of said established circuit, said method comprising the steps of:
detecting said failure of said established circuit between a first optical node and a second optical node of said established circuit;
reporting said failure of said established circuit to a control optical node in said optical layer by one of said first optical node and said second optical node; and
with said control optical node initiating restoration of said established circuit between said first optical node and said second optical node of said established circuit.

2. The method of claim 1, further comprising the step of recording a number of said failures over a period of time to determine performance metrics of said switched communication network.

3. The method of claim 1, wherein said failure concerns a communication link coupled to said first optical node and to said second optical node.

4. The method of claim 3, wherein said communication link comprises a trunk.

5. The method of claim 4, wherein said communication link comprises a channel of said trunk.

6. The method of claim 1, further comprising the step of regenerating said established circuit from a source optical node of said established circuit where said restoration of said established circuit between said first optical node and said second optical node fail to restore said established circuit.

7. The method of claim 4, further comprising the step of routing traffic between said first optical node and said second optical node through a said restored trunk.

8. The method of claim 1 further comprising the step of generating a revised path trace to indicate said restoration of said established circuit.

9. The method of claim 1, wherein said first optical node is said control optical node.

10. The method of claim 1, wherein said second optical node is said control optical node.

11. The method of claim 1, wherein said established circuit comprises a label switched path (LSP).

12. The method of claim 1, wherein said optical nodes comprise optical cross connect switches.

13. A method of restoring an established circuit in a communication network, said method comprising the steps of:
detecting a failed trunk and/or channel between a first optical node and a second optical node of said communication network wherein said detection is made by one of said first optical node and/or said second optical node wherein one of the nodes is a control node;
reporting said detected failed trunk to the control optical node; and
at said control optical node selecting an alternative trunk coupled to said first optical node and said second optical node to restore said established circuit.

14. The method of claim 13, further comprising the step of at said control optical node routing network traffic over said alternative trunk.

15. The method of claim 13, wherein said communication network includes a network topology database to track network topology and said method further comprising the step of, revising a network topology database to indicate the selection of said alternative trunk.

16. The method of claim 15, wherein said control optical node comprises one of the first optical node and the second optical node.

17. The method of claim 13, wherein said first optical node and said second optical node comprise an optical cross connect switch.

18. The method of claim 13, wherein said alternative trunk has a bandwidth capacity equivalent to said failed trunk.

19. The method of claim 13, wherein said alternative trunk has a bandwidth capacity that exceeds said failed trunk.

20. The method of claim 13, wherein said selection of said alternative trunk assigns a label switched path to said alternative trunk.

21. A computer readable medium holding computer executable instruction to perform a method of handling a failure of an established optical circuit in a switched communication network having an optical layer for photonic transport of data, to avoid tear down and re-establishment of said established circuit, said method comprising the steps of:
detecting said failure of said established circuit between a first optical node and a second optical node of said established circuit;
reporting said failure of said established circuit to a control optical node in said optical layer by one of said first optical node, and said second optical node; and
with said control optical switch initiating restoration of said established circuit between said first optical node and said second optical node of said established circuit.

22. The computer readable medium of claim 21, further comprising the step of recording a number of said failures over a period of this to determine performance metrics of said switched communication network.

23. The computer readable medium of claim 21, wherein said failure concerns a communication link coupled to said first optical node and to said second optical node.

24. The computer readable medium of claim 23, wherein said communication link comprises a trunk.

25. The computer readable medium of claim 24, wherein said communication link comprises a channel of said trunk.

26. The computer readable medium of claim 21, further comprising the step of regenerating said established circuit from a source optical node of said established circuit where said restoration of said established circuit between said first optical node and said second optical node fail to restore.

27. The computer readable medium of claim 24, further comprising the step of routing traffic between said first optical node and said second optical node through a said restored trunk.

28. The computer readable medium of claim 21 further comprising the step of generating a revised path trace to indicate said restoration of said established circuit.

29. The computer readable medium of claim 21, wherein said first optical node is said control optical node.

30. The computer readable medium of claim 21, wherein said second optical node is said control optical node.

31. The computer readable medium of claim 21, wherein said established circuit comprises a label switched path (LSP).
